(19) United States
(12) Patent Application Publication
(10) Pub. No.: US 2020/0097914 A1
(43) Pub. Date: Mar. 26, 2020

(54) Contextual User Interface Notifications

(71) Applicant: Microsoft Technology Licensing, LLC, Redmond, WA (US)

(72) Inventors: Noelle Renee Beaujon, Seattle, WA (US); Sandeep Seri, Bothell, WA (US); Nagendra Kalyan Nanduru, Redmond, WA (US); Chungheong Gooi, Redmond, WA (US); Justin J. Fagnan, Bellevue, WA (US); Lian Lu, Redmond, WA (US); Siqi Yang, Redmond, WA (US); Stefani Bartz, Redmond, WA (US); Wendy Guo, Redmond, WA (US); Jinkai Zhang, Redmond, WA (US); Bichong Li, Redmond, WA (US)

(21) Appl. No.: 16/230,978

(22) Filed: Dec. 21, 2018

Related U.S. Application Data
(60) Provisional application No. 62/735,145, filed on Sep. 23, 2018.

(51) Int. Cl. G06Q 10/10; G06F 9/54; G06F 9/451

(52) U.S. Cl. CPC G06Q 10/109; G06F 9/451; G06F 9/542; G06Q 10/107

(57) ABSTRACT

A method may include receiving an indication that a user is composing an electronic message in a client application; in response to the indication, determining that a time of the electronic message is being composed is within a trigger time period; based on the determination: accessing a frequency of electronic message composition during the trigger time period for the user; and accessing a frequency of response messages, during the trigger time period, transmitted to the user in response to messages composed by the user during the trigger time period; and when the frequency of message composition is above a first threshold and the frequency of response messages is above a second threshold: presenting a notification within the client application, the notification including an option to consider adding an addendum to the electronic message.

### CROSS-RELATED APPLICATIONS

This patent application claims the benefit of priority, under 35 U.S.C. § 119(e), to U.S. Provisional Patent Application Ser. No. 62/735,145, titled “Contextual User Interface Notifications,” filed on Sep. 23, 2018, which is incorporated by reference in its entirety.

### BACKGROUND

Productivity and communication software helps users view mail, contact, and task information in a centralized location. The software also permits users to transmit meeting requests, e-mails, and create tasks. Sometimes the software allows other developers to enhance the functionality of the underlying software. For example, a voice over IP application may insert call-in information into a meeting request.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a schematic representation of a context-based user notification system, according to various examples.

FIG. 2 is a user interface that illustrates a focus time notification, according to various examples.

FIG. 3 is a flowchart illustrating a method to present a focus time notification, according to various examples.

FIG. 4 is a user interface that illustrates a non-completed tasks notification, according to various examples.

FIG. 5 is a flowchart illustrating a method to present a non-completed tasks notification, according to various examples.

FIG. 6 is a user interface that illustrates a message composition interface, according to various examples.

FIG. 7 is a flowchart illustrating a method to present a message addendum notification, according to various examples.

FIG. 8 is a block diagram illustrating an example machine upon which any one or more of the techniques (e.g., methodologies) discussed herein may be performed, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, the disclosure does not always detail where the variables are stored or how they are retrieved. In such instances, it may be assumed that the variables are stored on a storage device accessible by the component via an API or other program communication method. Similarly, the variables may be assumed to have a default values should a specific value not be described. User interfaces may be provided for an end-user or administrator to edit the variable values in some instances.

Modern productivity and communication software applications help a user manage their calendar appointments, mail, and tasks, etc. A problem with such software is that the volume of information maintained by the software makes it difficult to display all the information needed by the user at the same time. This becomes especially acute with limited display devices such as mobile devices. For example, if a user receives a meeting request, the software application may display whether the user is free during the requested time but provide no insights or information about the rest of the day or week. The user may then accept an appointment without knowing that the rest of the user's week is booked solid. Similarly, if a user receives an e-mail message the user may not be aware of all the tasks outstanding for the sender of the message without opening the task portion of the software.

In another example, a user may constantly send messages at late hours—prompting recipients to respond even if the message is not urgent. The sender may not know the frequency that the user's recipients are responding and, if prompted, may have indicated that the messages were not important.

Accordingly, the user interfaces of existing software applications are insufficient to provide information to users to make intelligent decisions. Described herein is an insight framework that provides notifications to users at the same time as actions taken by the user or in response to events in the software application. In such a manner, the user may see context-based notifications that help the user act upon events (e.g., meetings, e-mails) received at the software application. When an insight is activated, an interface pane may be presented with a workflow for the user to act on the insight. Insights may include scheduling focus work time, reviewing tasks for a particular recipient, and adding addendums to messages as they are composed, among others.

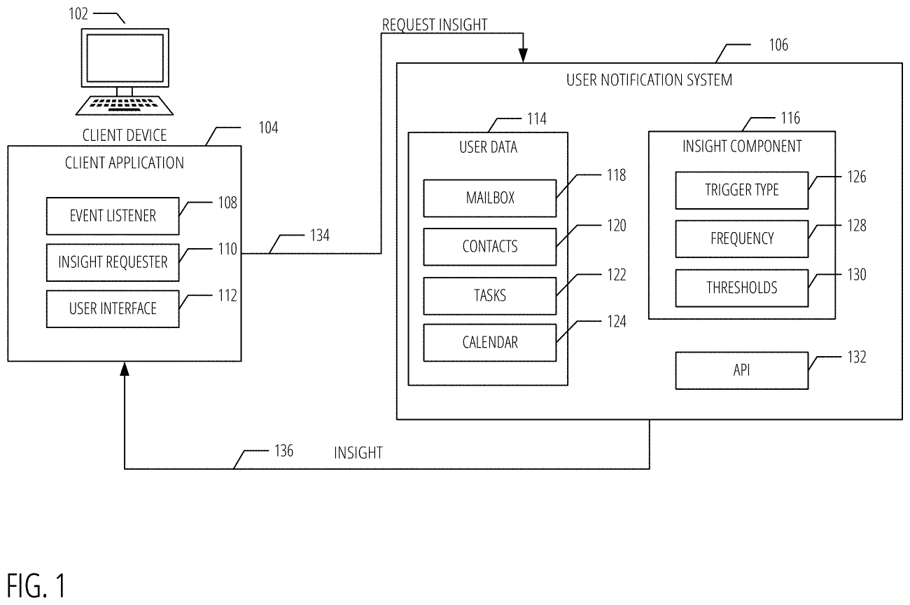

FIG. 1 is a schematic representation of a context-based user notification system, according to various examples. FIG. 1 includes client device 102, client application 104, and user notification system 106. Client application 104 includes event listener 108, insight requester 110, and user interface 112, in various examples. User notification system 106 includes user data 114, which includes mailbox 118, contacts 120, tasks 122, and calendar 124 in various examples. User notification system 106 further includes insight component 116, which includes trigger type 126, frequency 128, and thresholds 130. User notification system 106 also includes Application Programming Interface (API) 132 in various examples. Client application 104 transmit request 134 for insights to user notification system 106. User notification system 106 may respond with insight 136.

For illustration purposes, client application 104 and user notification system 106 are illustrated as sets of separate functional units (e.g., event listener 108, insight requester 110, insight component 116. etc.). The functionality of multiple functional units, however, may be performed by a single unit. A functional unit may represent computer program code that is executable by a processing unit (e.g., a core of a general-purpose computer processor, a graphical processing unit, an application specific integrated circuit, etc.) The program code may be stored on a storage device and loaded into a memory of the processing unit for execution. Portions of the program code may be executed in a parallel across multiple processing units. Execution of the code may be performed on a single device or distributed across multiple devices. In some example, the program code is executed on a cloud platform (e.g., MICROSOFT AZURE® and AMAZON EC2®) using shared computing infrastructure. Similarly, functions described as being performed by client application 104 may be performed at user notification system 106 and vice a versa.

In various examples, client device 102 and user notification system 106 may communicate via one or more networks (not illustrated). A network may include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. A network may include a single local area network (LAN) or wide-area network (WAN), or combinations of LAN's or WAN's, such as the Internet, Client device 102 may issue requests for data such as user data 114 or an insight using API 132.

Because of the potential sensitive nature of data stored within user data 114, various security measures may be used to protect data at rest and in transmit. For example, API 132 may use tokens or API keys to ensure only authorized parties may retrieve or update data from user notification system 106. Additionally, data transmitted over the network may use a cryptographic protocol, such Secure Socket Layer (SSL) or Transport Layer Security (TLS). As a further security precaution, the transmitted data itself may be encrypted, separately from the SSL or TLS encryption, Public-key infrastructure (PM) may be leveraged for SSL/TLS as well as the separate data encryption. User notification system 106 may also require that a user opt-in to analysis of the user's data before insights are delivered to the user.

Client device 104 may be, but is not limited to, a smartphone, tablet, laptop, multi-processor system, microprocessor-based or programmable consumer electronics, game console, set-top box, or any other device that a user utilizes to communicate over a network. In example embodiments, client device 104 includes a display module (not shown) to display information (e.g., in the form of specially configured user interfaces). In some embodiments, client device 102 may include one or more of a touch screen, camera, keyboard, microphone, and Global Positioning System (GPS) device.

Client application 104 may be a productivity and communication software application such as the MICROSOFT OUTLOOK® software application. Client application 104 may include features to send and receive electronic message e.g., e-mail), create and complete tasks, schedule calendar appointments, and manage contacts. Client application 104 may be a stand-alone application executing on client device 102. In various examples, client application 104 is a web application served by user notification system 106.

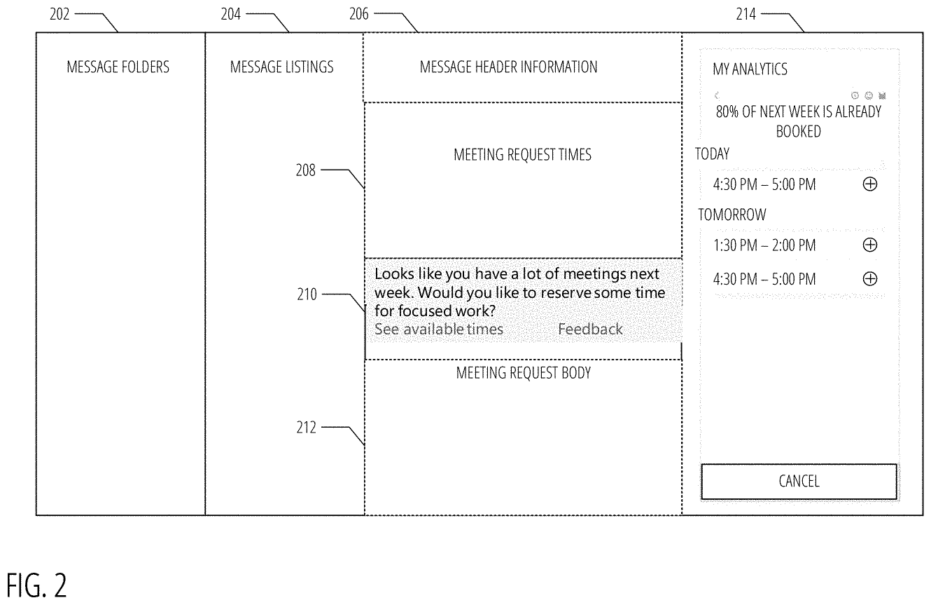

Client application 104 may be configured with extensibility enabled to allow plugins, such as event listener 108, to listen for events. Events may be actions taken by a user or activity within client application 104. For example, a plugin may be developed to perform an action in response to an e-mail being composed by a user within client application 104. Insight requester 110 may request insights from user notification system 106 in various situations. Insights may be displayed to a user within client application 104 as a notification such as depicted FIG. 2 and FIG. 4 and FIG. 6.

User data 114 may store data for each user of client application 104 A user's data may be accessible via stand alone or web-based versions of client application 104. In various examples, user data 114 is managed by a synching service such as Exchange ActiveSync.

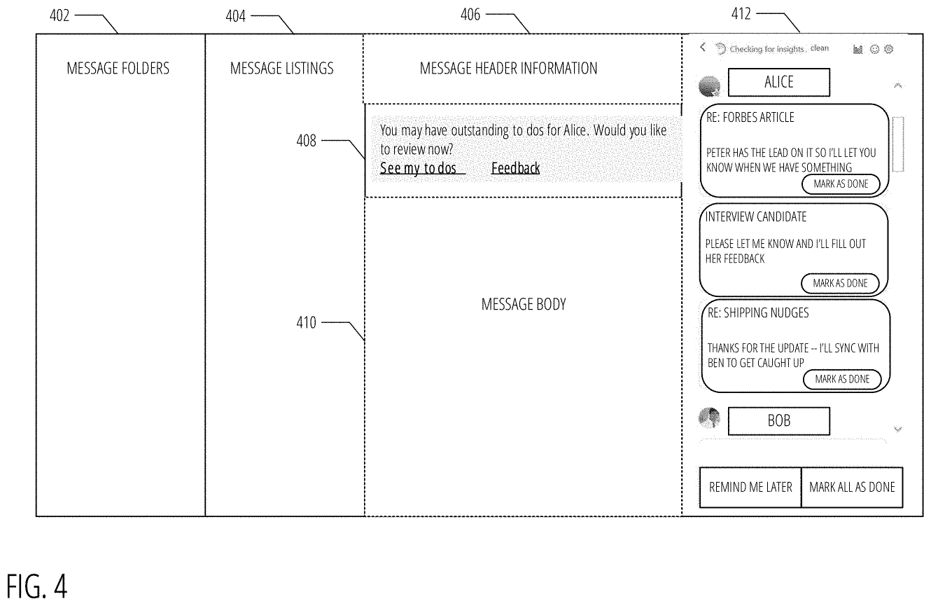

User interface 112 may be configured in a variety of manners for presenting client application 104 to the user. For example, user interface 112 may be arranged as a series of vertical interface panes with increasing levels of granularity from left-to-right in some examples, in other examples, a single interface pane is used by a user. User interface 112 may allow for multiple windows to be displayed simultaneously. In various examples, plugins are permitted to modify user interface 112. For example, a notification from user notification system 106 may be displayed in an interface pane that is displaying the body of an e-mail message. Example interfaces are illustrated in FIG. 2, FIG. 4 and FIG, 6.

Insight component 116 may define a set of insights available for presenting to users depending on a set of conditions. For example, trigger type 126 may define whether an insight is applicable to a meeting request, an e-mail, a task, etc. Accordingly, if insight requester 110 requests if there are any insights for an e-mail, only rules with insights that are applicable to e-mail may be checked.

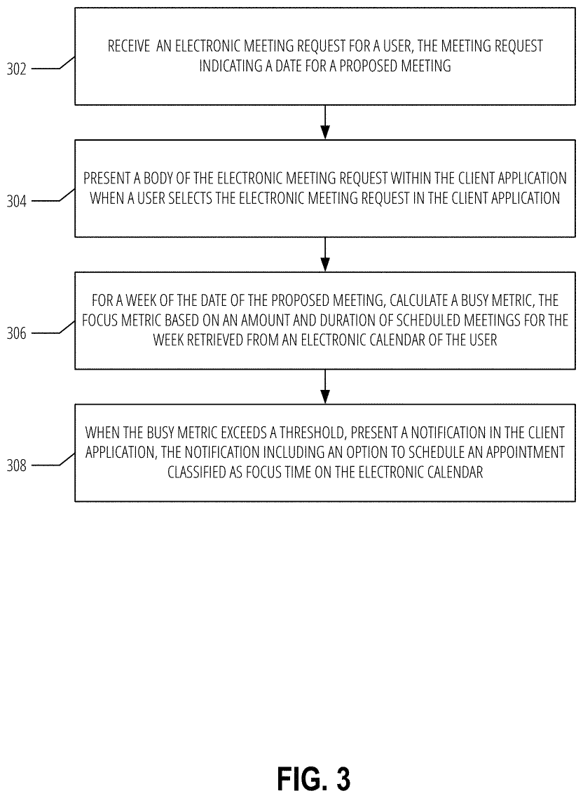

Frequency 128 may define how often an insight is presented to a user. For example, a focus time insight—discussed in more detail with respect to FIG. 2 and FIG. 3—may be displayed a maximum of five times a week and two times a week. Frequency 128 may change depending on feedback from a user. For example, a user may indicate negative feedback (e.g., click a thumb down) for the focus time notification. In such as instance, the focus time notification may be suppressed for a period of time (e.g., the rest of the week). If a user continually indicates negative feedback, the suppression period may increase each time (e.g., a week to a month to three months).

Thresholds 130 may define the rules for when to present an insight. For example, for a focus time notification, a threshold of 30% of blocked time for a week of a calendar may be the threshold for displaying suggestions to block off time as focus work on the user's calendar.

FIG. 2 is a user interface that illustrates a focus time notification, according to various examples. The user interface is presented as a set of interface panes; however, other user interface arrangements may be used without departing from the scope of this disclosure. Message folder 202 may display folders of e-mails for user. Message listings 204 may display the messages received for a folder selected in message folders 202. In various examples, a selected message in message listings 204 may be a meeting request.

Message header information 206 may identify the sender and invited attendees of a meeting request. User interface section 208 may include a graphical representation of the time the meeting is requested for in the context of a user's current calendar. User interface section 212 may present the body of the meeting request (e.g., text entered by the sender).

Notification 210 may be presented in response to a request for insights from a client application to a notification system. In various examples, the notification is presented based on rules that are part of the client application. Notification 210 indicates that the user has a busy week and suggests reserving some time to focus.

Interface pane 214 may be presented when the user selects the “see available times” option in notification 210. Interface pace 214 indicates that 80% of the next week is already busy and suggests a few times to reserve for focused work time. A user may click the plus symbols to modify the time or accept the focused work time. Focused work time may appear as a separate color in the user's calendar.

FIG. 3 is a flowchart illustrating a method to present a focus time notification, according to various examples. The method is represented as a set of blocks that describe operations 302-308 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 3. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

At operation 302, in various examples, an electronic meeting request for a user is received. For example, the electronic meeting request may be received in a mailbox of the user. The meeting request may indicate a date for a proposed meeting with the user.

At operation 304, in various examples, a body of the electronic meeting request may be displayed within a client application when a user selects the electronic meeting request in the client application. The body may include a message from the sender of the meeting request.

At operation 306, in various examples, a busy metric may be calculated. The busy metric may be calculated when the users selects the electronic meeting request. Accordingly, the calculation may be delayed until the user selects the electronic meeting request. A plugin of the client application may request the busy metric be calculated. In another example, a request may be transmitted to an external server (e.g., user notification system 106) to see if any notifications should be presented based on receipt of a meeting request. Thus, user notification system 106 may initiate the calculation in various examples. In various, the busy metric is calculated when the meeting request is received and before the user selects the meeting request.

The busy metric may be calculated for the week for the week of the proposed meeting. In some examples, the busy metric is calculated for a week following the current week. The busy metric may be based on an amount and duration of scheduled meetings for the week retrieved from an electronic calendar of the user. For example, a user may be considered busy if there not free time for at least a set amount of time (e.g., two hours). Consider that there is a 30-minute meeting at 10 AM, a 30 meeting at 11 AM and another meeting then an hour meeting at 1:30, the user would be considered busy from 10 AM until 11:30 and free from 11:30 until 1:30. The busy metric may exclude non-work hours (e.g., before 8 AM or after 5 PM). The busy metric may be the percentage of time the user is not free for the week. If a meeting is set as focus time or is a meeting with only the user as an attendee, the meeting is not considered busy, in various examples.

At operation 308, in various examples, when the busy metric exceeds a threshold (e.g., 30%), a notification may be presented in the client application. The notification may include an option to schedule an appointment classified as focus time on the electronic calendar of the user. In various examples, the threshold may be user-specific. In various examples, a user interface element may be presented to change the threshold.

In various examples, before presenting the notification, a determination may be made that a maximum number of notifications for a time period has not been reached. The maximum number may be user specific based on feedback provided by the user. For example, presenting the notification in the client application may include presenting a notification feedback option. The notification feedback option may provide an opportunity for the user to indicate the user wishes to see fewer notifications for focus time. Accordingly, an indication of negative feedback may be received from the presented notification feedback option. In response to the negative feedback future notifications with options to scheduled appointments classified as focus time may be suppressed for a period of time. Notifications with options to scheduled appointments classified as focus time may be resumed after the period of time has lapsed.

In various examples, the method may include additional operations. For example, an indication may be received (e.g., an event message of a click) that the option to add focus time has been accepted by the user. In response, a user interface pane may be presented within the client application with a proposed time block for focus time on the electronic calendar of the user. Then, the appointment classified as focus time may be scheduled when the user accepts the proposed time block.

The operations may further include receiving a subsequent meeting request for a time period that overlaps at least part of a proposed time block of the appointment. In response to receiving the subsequent meeting request, a notification may be presented with an option to propose a new meeting time for the subsequent meeting request or move the proposed time block, in some examples, if the subsequent meeting cannot be moved, an interface may be presented with suggested contacts to take the place of the user at the meeting.

FIG. 4 is a user interface that illustrates a non-completed tasks notification, according to various examples. The user interface is presented as a set of interface panes; however, other user interface arrangements may be used without departing from the scope of this disclosure. Message folder 402 may display folders of e-mails for user. Message listings 404 may display the messages received for a folder selected in message folders 402. In various examples, a selected message in message listings 404 may be an e-mail from a sender.

Message header information 406 may identify the sender and invited attendees of a meeting request. User interface section 410 may present the body of the e-mail (e.g., text entered by the sender, Alice).

Notification 408 may be presented in response to a request for insights from a client application to a notification system. In various examples, the notification is presented based on rules that are part of the client application. Notification 408 indicates that the user has outstanding tasks associated with the sender of a selected message.

Interface pane 412 may be presented when the user selects the “see my todos” option in notification 408. Interface pace 412 indicates a set of non-completed tasks for Alice, a snippet of information about each task, and an option to mark each task completed. A further option is presented to reminder a user later about the non-completed tasks.

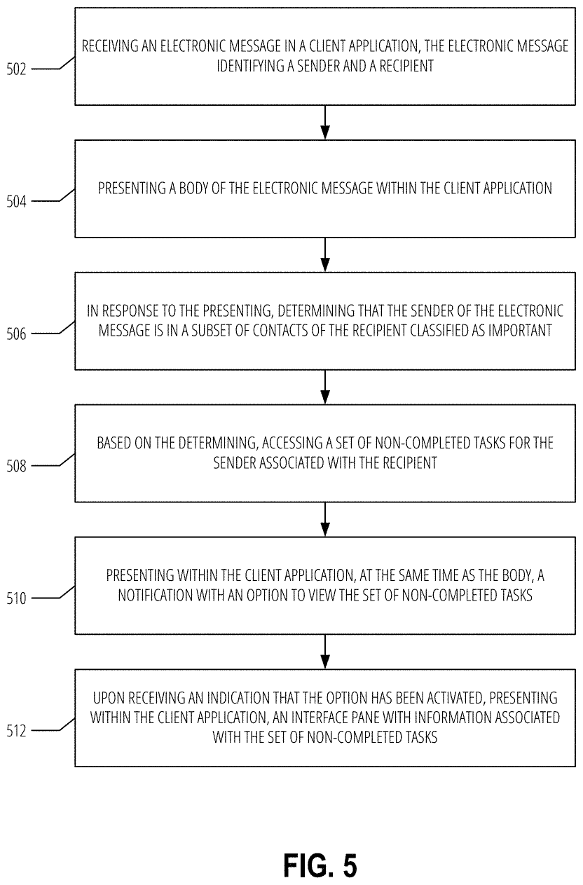

FIG. 5 is a flowchart illustrating a method to present a non-completed tasks notification, according to various examples. The method is represented as a set of blocks that describe operations 502-512 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 5. The one or more processors may instruct other component of the computing device(s) to carry out the set of instructions. For example, the computing device may instruct a network device to transmit data to another computing device or the computing device may provide data over a display interface to present a user interface. In sonic examples, performance of the method may be split across multiple computing devices using a shared computing infrastructure.

At operation 502, in various examples an electronic message is received in a client application. The electronic message may identify a sender and a recipient.

At operation 504, in various examples, a body of the electronic message is presented within the client application. The presenting may be in response to a user selecting the electronic message.

At operation 506, in response to the presenting, a determination may be made that that the sender of the electronic message is in a subset of contacts of the recipient classified as important. For example, contacts of the user may be stored in a data store. Part of the data store may include a classification of the contact.

At operation 508, based on the determining, a set of non-completed tasks for the sender associated with the recipient may be accessed. The tasks may be stored as part of user data (e.g., tasks 122). Each stored task may have a creation date, a set of contacts associated with the task such as the assigner of the task, and a completion status. Accordingly, in various examples, accessing the set of non-completed tasks for the sender associated with the recipient may include retrieving respective creation dates for the non-completed tasks. In some examples, non-completed tasks from the set of non-completed tasks may be excluded when their respective creation date is outside of a time period window. The time period may be at least one day before the current date and not more than seven days in various examples.

At operation 510 in various examples, a notification may be presented within the client application with an option to view the set of non-completed tasks.

At operation 512, upon receiving an indication that the option has been activated, an interface pane may be presented within the client application with information associated with the set of non-completed tasks. The information may include a snippet of an e-mail from which a task was created, in various examples. The interface pane may include an option to mark a respective task of the set of non-completed tasks complete. The interface pane may include an option to remind the user later, within the application, of a respective task of the set of non-completed tasks.

In various examples, before presenting the notification, a determination may be made that a maximum number of notifications for a time period has not been reached. The maximum number may be user specific based on feedback provided by the user. For example, presenting the notification in the client application may include presenting a notification feedback option. The notification feedback option may provide an opportunity for the user to indicate the user wishes to see fewer notifications for non-completed tasks. Accordingly, an indication of negative feedback may be received from the presented notification feedback option. In response to the negative feedback future notifications with options to view non-completed tasks may be suppressed for a period of time. Notifications with an option to view non-completed tasks may be resumed after the period of time has lapsed.

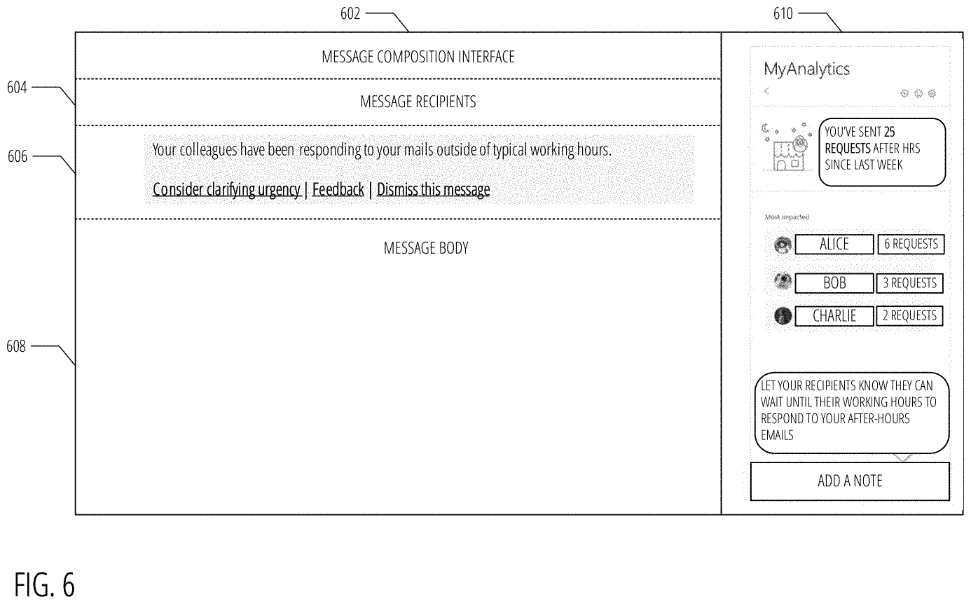

FIG. 6 is a user interface that illustrates a message composition interface 602, according to various examples. The user interface is presented as a set of interface portions; however, other user interface arrangements may be used without departing from the scope of this disclosure. User interface portion 604 may include entry boxes for a user to enter in intended recipients for content typed into message body 608.

Notification 406 may be presented in response to a request for insights from a client application to a notification system. The request may be initiated by an event listening process such as event listener 108 in FIG. 1. The notification may only appear once one or more thresholds have been met. For example, the notification may not appear unless the user is composing the message after a set of defined work hours. Another threshold may be the frequency the user composes and sends messages after work hours. Another threshold may be the frequency the recipients of the messages response to the user during after work hours.

Interface pane 610 may be presented when the user selects the “consider clarifying urgency” option in notification 606. Interface pace 610 identifies a number of after messages sent by the user in the previous week, as well as the contacts of the user that have responded to those messages. An option is presented in interface pane 610 to add additional content to the message body 608 that indicates that the message is not urgent and can be responded to during regular work hours.

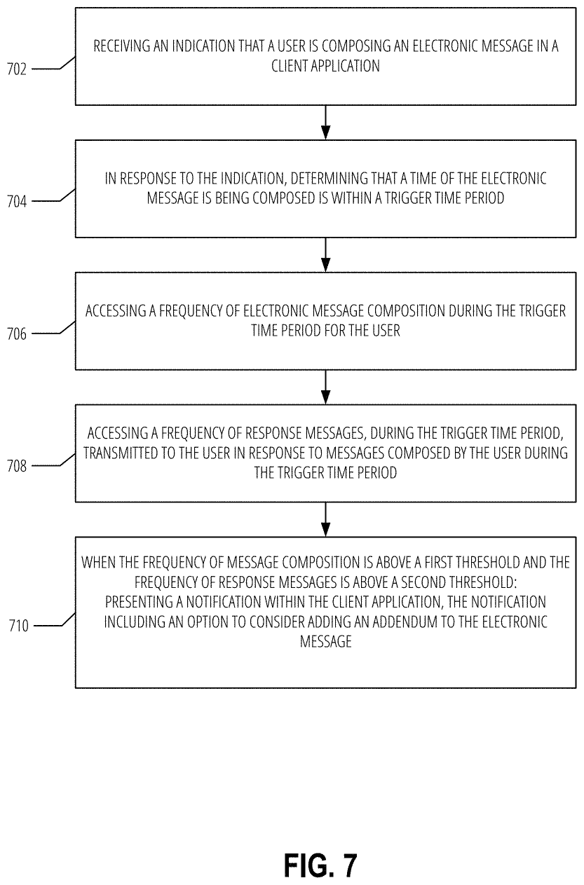

FIG. 7 is a flowchart illustrating a method to present a message addendum notification, according to various examples. The method is represented as a set of blocks that describe operations 702-710 of the method. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 7. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure

At operation 702, in various examples, an indication is received that a user is composing an electronic message in a client application. For example, an event listener may receive notice from the client application of a message compose event.

At operation 704, in various examples, in response to the indication, it is determined if a time of the electronic message is being composed is within a trigger time period. A time period may be based on a time or specific days (e.g., after 5 PM, before 6 AM, and all-day Saturday and Sundays).

If the user is composing a message during the trigger time period a frequency of electronic message composition during the trigger time period for the user may be accessed at operation 706. Accessing may include transmitting a message to an external server (e.g., user notification system 106) or querying sent messages via the client application.

At operation 708, in various examples, a frequency of response messages may be determined, during the trigger time period, of responses to messages composed by the user during the trigger time period. For example, how many people respond to a message off work-hours (e.g., the trigger time period) for messages sent by the user during the trigger time period. In some examples, if a recipient responds after the next available work day, the message is not included when calculating the frequency. For example, if a user composes a message at 9 PM on Monday and the recipient responds at 9 PM on Tuesday, the response is not counted as a response message during the trigger period.

At operation 710, in various examples, when the frequency of message composition is above a first threshold and the frequency of response messages is above a second threshold, a notification may be presented within the client application. The notification may include an option to consider adding an addendum to the electronic message currently being composed.

When the option is accepted, an interface pane may be presented in the client application. The interface pane may include the frequency of electronic message composition during the trigger time period for the user. The frequency may be based on the past week in various examples.

The interface pane may include a set of contacts that replied to any message composed by the user during the trigger time period. The user interface pane may further include a number of times each respective contact in the set of contacts replied to any message composed by the user during the trigger time period. Replies during times outside of the trigger time period may be excluded.

The user interface pane may further include a user interface element to add the addendum to the electronic message. The addendum may indicate a recipient of the electronic message can respond outside of the trigger time period. In various examples, before presenting the notification, a determination may be made that a maximum number of notifications for the trigger time period has not been reached. The maximum number may be user specific based on feedback provided by the user. For example, presenting the notification in the client application may include presenting a notification feedback option. The notification feedback option may provide an opportunity for the user to indicate the user wishes to see fewer notifications for adding a message addendum. Accordingly, an indication of negative feedback may be received from the presented notification feedback option. In response to the negative feedback future notifications with options to consider adding a message addendum may be suppressed for a period of time. Notifications with an option to add a message addendum may be resumed after the period of time has lapsed.

Example Computer System and Example Methods p Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

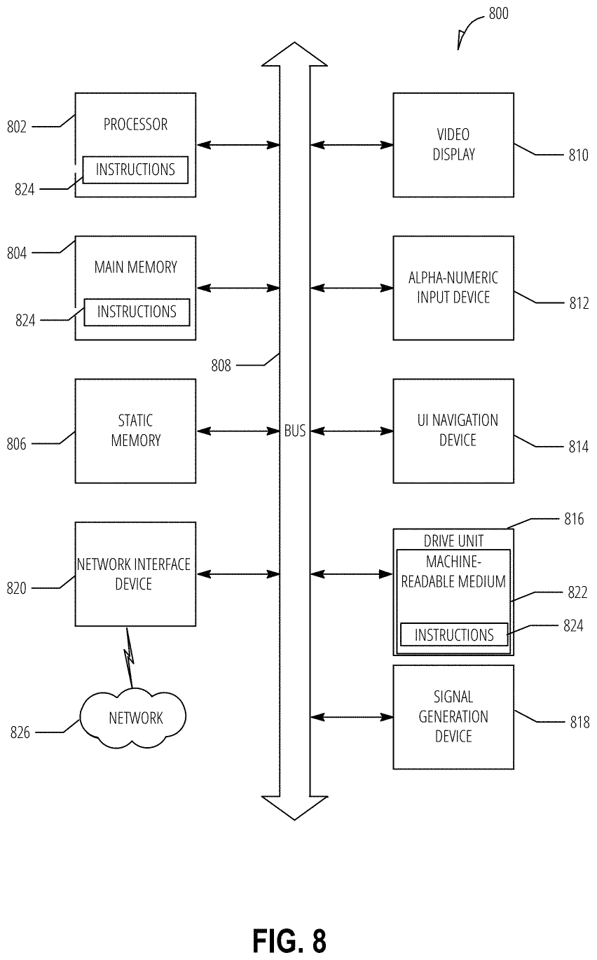

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or bath, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (U1) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or another sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., 80, and 40 LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Example 1 is a method comprising receiving an electronic meeting request for a user, the meeting request indicating a date for a proposed meeting; presenting a body of the electronic meeting request within a client application when a user selects the electronic meeting request in the client application; for the week of the date of the proposed meeting, calculating a busy metric, the focus metric based on an amount and duration of scheduled meetings for the week retrieved from an electronic calendar of the user; when the busy metric exceeds a threshold, presenting a notification in the client application, the notification including an option to schedule an appointment classified as focus time on the electronic calendar.

In Example 2, the subject matter of Example 1 optionally includes receiving an indication that the option has been accepted by the user; and presenting a user interface pane within the client application with a proposed time block on the electronic calendar of the user; and scheduling the appointment classified as focus time when the user accepts the proposed time block.

In Example 3, the subject matter of Example 2 optionally includes receiving a subsequent meeting request for a time period that overlaps at least part of a proposed time block of the appointment; in response to receiving the subsequent meeting request, presenting a notification with an option to propose a new meeting time for the subsequent meeting request or move the proposed time block.

In Example 4, the subject matter of any one or more of Examples 1-3 optionally include wherein presenting the notification in the client application includes presenting a notification feedback option.

In Example 5, the subject matter of Example 4 optionally includes receiving an indication of negative feedback from the presented notification feedback option; suppressing future notifications with options to scheduled appointments classified as focus time for a period of time; and resuming notifications with options to scheduled appointments classified as focus time after the period of time has lapsed.

In Example 6, the subject matter of any one or more of Examples 1-5 optionally include wherein the threshold is specific to the user.

In Example 7, the subject matter of Example 6 optionally includes presenting a user interface element to change the threshold.

In Example 8, the subject matter of any one or more of Examples 1-7 optionally include before presenting the notification, determining that a maximum number of notifications for a time period has not been reached.

Example 9 is a method comprising: receiving an electronic message in a client application, the electronic message identifying a sender and a recipient; presenting a body of the electronic message within the client application; in response to the presenting, determining that the sender of the electronic message is in a subset of contacts of the recipient classified as important; based on the determining, accessing a set of non-completed tasks for the sender associated with the recipient; presenting within the client application a notification with an option to view the set of non-completed tasks; and upon receiving an indication that the option has been activated, presenting within the client application, an interface pane with information associated with the set of non-completed tasks.

In Example 10, the subject matter of Example 9 optionally includes wherein accessing the set of non-completed tasks for the sender associated with the recipient includes: retrieving respective creation dates for the non-completed tasks; excluding a respective non-completed task from the set of non-completed tasks when the respective creation date is outside of a time period window.

In Example 11, the subject matter of any one or more of Examples 9-10 optionally include hours old.

In Example 12, the subject matter of any one or more of Examples 9-11 optionally include wherein the time period excludes non-completed tasks with creation dates that more than seven days old.

in Example 13, the subject matter of any one or more of Examples 9-12 optionally include wherein presenting the interface pane with information on the set of non-completed tasks includes presenting an option to mark a respective task of the set of non-completed tasks complete.

In Example 14, the subject matter of any one or more of Examples 9-13 optionally include wherein presenting the interface pane with information on the set of non-completed tasks includes presenting an option to remind the user later, within the application, of a respective task of the set of non-completed tasks.

In Example 15, the subject matter of any one or more of Examples 9-14 optionally include wherein presenting the notification in the client application includes presenting a notification feedback option.

In Example 16, the subject matter of Example 15 optionally includes receiving an indication of negative feedback from the presented notification feedback option; suppressing future notifications with an option to view a set of non-completed tasks for a period of time; and resuming notifications with an option to view a set of non-completed tasks after the period of time has lapsed.

In Example 17, the subject matter of any one or more of Examples 9-16 optionally include before presenting the notification, determining that a maximum number of notifications for a time period has not been reached.

Example 18 is a method comprising: receiving an indication that a user is composing an electronic message in a client application; in response to the indication, determining that a time of the electronic message is being composed is within a trigger time period; based on the determination: accessing a frequency of electronic message composition during the trigger time period for the user; and accessing a frequency of response messages, during the trigger time period, transmitted to the user in response to messages composed by the user during the trigger time period; and when the frequency of message composition is above a first threshold and the frequency of response messages is above a second threshold: presenting a notification within the client application, the notification including an option to consider adding an addendum to the electronic message.

In Example 19, the subject matter of Example 18 optionally includes receiving an indication of acceptance of the option; and in response to receiving the indication of acceptance, presenting an interface pane in the client application, the interface pane including the frequency of electronic message composition during the trigger time period for the user.

In Example 20, the subject matter of any one or more of Examples 18-19 optionally include receiving an indication of acceptance of the option; and in response to receiving the indication of acceptance, presenting an interface pane in the client application, the interface pane including a set of contacts that replied to any message composed by the user during the trigger time period.

In Example 21, the subject matter of Example 20 optionally includes wherein the user interface pane further includes a number of times each respective contact in the set of contacts replied to any message composed by the user during the trigger time period.

In Example 22, the subject matter of any one or more of Examples 20-21 optionally include wherein the user interface pane further includes a user interface element to add the addendum to the electronic message, the addendum indicating a recipient of the electronic message can respond outside of the trigger time period.

In Example 23, the subject matter of any one or more of Examples 18-22 optionally include wherein presenting the notification in the client application includes presenting a notification feedback option.

In Example 24, the subject matter of Example 23 optionally includes receiving an indication of negative feedback from the presented notification feedback option; suppressing future notifications with an option to consider adding an addendum to the electronic message for a period of time; and resuming notifications with an option to consider adding an addendum to the electronic message after the period of time has lapsed.

In Example 25, the subject matter of any one or more of Examples 18-24 optionally include before presenting the notification, determining that a maximum number of notifications for the trigger time period has not been reached.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

What is claimed is:

1. A system comprising:
at least one processor;
a storage device comprising instructions, which when executed by the at least one processor, configure the at least one processor to perform operations comprising:
receiving an indication that a user is composing an electronic message in a client application;
in response to the indication, determining that a time of the electronic message is being composed is within a trigger time period;
based on the determination:
accessing a frequency of electronic message composition during the trigger time period for the user; and
accessing a frequency of response messages, during the trigger time period, transmitted to the user in response to messages composed by the user during the trigger time period; and
when the frequency of message composition is above a first threshold and the frequency of response messages is above a second threshold:
presenting a notification within the client application, the notification including an option to consider adding an addendum to the electronic message.

2. The system of claim 1, the operations further comprising:
receiving an indication of acceptance of the option; and
in response to receiving the indication of acceptance, presenting an interface pane in the client application, the interface pane including the frequency of electronic message composition during the trigger time period for the user.

3. The system of claim 1, the operations further comprising:
receiving an indication of acceptance of the option; and
in response to receiving the indication of acceptance, presenting an interface pane in the client application, the interface pane including a set of contacts that replied to any message composed by the user during the trigger time period.

4. The system of claim 3, wherein the user interface pane further includes a number of times each respective contact in the set of contacts replied to any message composed by the user during the trigger time period.

5. The system of claim 3, wherein the user interface pane further includes a user interface element to add the addendum to the electronic message, the addendum indicating a recipient of the electronic message can respond outside of the trigger time period.

6. The system of claim 1, wherein the operation of presenting the notification in the client application includes presenting a notification feedback option.

7. The system of claim 6, the operations further comprising:
receiving an indication of negative feedback from the presented notification feedback option;
suppressing future notifications with an option to consider adding an addendum to the electronic message for a period of time; and
resuming notifications with an option to consider adding an addendum to the electronic message after the period of time has lapsed.

8. The system of claim 1, the operations further comprising:
before presenting the notification, determining that a maximum number of notifications for the trigger time period has not been reached

9. A method comprising:
receiving an indication that a user is composing an electronic message in a client application;
in response to the indication, determining that a time of the electronic message is being composed is within a trigger time period;
based on the determination:
accessing a frequency of electronic message composition during the trigger time period for the user; and
accessing a frequency of response messages, during the trigger time period, transmitted to the user in response to messages composed by the user during the trigger time period; and
when the frequency of message composition is above a first threshold and the frequency of response messages is above a second threshold:
presenting a notification within the client application, the notification including an option to consider adding an addendum to the electronic message.

10. The method of claim 9, further comprising:
receiving an indication of acceptance of the option; and
in response to receiving the indication of acceptance, presenting an interface pane in the client application, the interface pane including the frequency of electronic message composition during the trigger time period for the user.

11. The method of claim 9, further comprising:
receiving an indication of acceptance of the option; and
in response to receiving the indication of acceptance, presenting an interface pane in the client application, the interface pane including a set of contacts that replied to any message composed by the user during the trigger time period.

12. The method of claim 11, wherein the user interface pane further includes a number of times each respective contact in the set of contacts replied to any message composed by the user during the trigger time period.

13. The method of claim 11, wherein the user interface pane further includes a user interface element to add the addendum to the electronic message, the addendum indicating a recipient of the electronic message can respond outside of the trigger time period.

14. The method of claim 9, wherein presenting the notification in the client application includes presenting a notification feedback option.

15. The method of claim 14, further comprising:
receiving an indication of negative feedback from the presented notification feedback option;
suppressing future notifications with an option to consider adding an addendum to the electronic message for a period of time; and
resuming notifications with an option to consider adding an addendum to the electronic message after the period of time has lapsed.

16. The method of claim 9, further comprising:
before presenting the notification, determining that a maximum number of notifications for the trigger time period has not been reached.

17. A storage device comprising instructions, which when executed by at least one processor, configure the at least one processor to perform operations comprising:
receiving an indication that a user is composing an electronic message in a client application;
in response to the indication, determining that a time of the electronic message is being composed is within a trigger time period;
based on the determination:
accessing a frequency of electronic message composition during the trigger time period for the user; and
accessing a frequency of response messages, during the trigger time period, transmitted to the user in response to messages composed by the user during the trigger time period; and
when the frequency of message composition is above a first threshold and the frequency of response messages is above a second threshold:
presenting a notification within the client application, the notification including an option to consider adding an addendum to the electronic message.

18. The storage device of claim 17, the operations further comprising:
receiving an indication of acceptance of the option; and
in response to receiving the indication of acceptance, presenting an interface pane in the client application, the interface pane including the frequency of electronic message composition during the trigger time period for the user.

19. The storage device of claim 17, the operations further comprising:
receiving an indication of acceptance of the option; and
in response to receiving the indication of acceptance, presenting an interface pane in the client application, the interface pane including a set of contacts that replied to any message composed by the user during the trigger time period.

20. The storage device of claim 19, wherein the user interface pane further includes a number of times each respective contact in the set of contacts replied to any message composed by the user during the trigger time period.
